(19) United States
(12) Patent Application Publication
(10) Pub. No.: US 2015/0204687 A1
(43) Pub. Date: Jul. 23, 2015

(54) APPARATUS AND METHOD OF GUIDING LANE CHANGE BASED ON AUGMENTED REALITY

(71) Applicant: ELECTRONICS AND TELECOMMUNICATIONS RESEARCH INSTITUTE, Daejeon (KR)

(72) Inventors: Chang Rak YOON, Daejeon (KR); Kyong Ho KIM, Daejeon (KR); Hye Sun PARK, Daejeon (KR)

(73) Assignee: ELECTRONICS AND TELECOMMUNICATIONS RESEARCH INSTITUTE, Daejeon (KR)

(21) Appl. No.: 14/598,838

(22) Filed: Jan. 16, 2015

(30) Foreign Application Priority Data
Jan. 22, 2014 (KR) 10-2014-0007795

(51) Int. Cl. G01C 21/36

(52) U.S. Cl. CPC G01C 21/3658; G01C 21/3635; G01C 21/3647

(57) ABSTRACT

Disclosed is a method of assisting a lane change based on augmented reality. In the method, when it is necessary to change a lane while a driver drives a vehicle to a destination, lane change guidance information based on augmented reality can be expressed in the sight line of the driver. Therefore, it is possible to eliminate inconvenience and distraction in the case of checking driving direction of the lane, thereby improving safety and convenience of the driving.

### CROSS-REFERENCE TO RELATED APPLICATION

This application claims priority to and the benefit of Korean Patent Application No. 10-2014-0007795, filed on Jan. 22, 2014, the disclosure of which is incorporated herein by reference in its entirety.

### BACKGROUND

1. Field of the Invention

The present invention relates to an apparatus and method of assisting lane changes based on augmented reality, and more particularly, to an apparatus and method of assisting lane changes based on augmented reality, which provides lane change information based on augmented reality in the sight line of a driver when it is necessary to change a driving lane.

2. Discussion of Related Art

A navigation device is a device or program that supports driving of a vehicle while showing a map or finding a shortcut. The navigation device has gradually increased in its utilization, but in order for a driver to visually check a map or guidance information provided by the navigation device, there is a problem in that it is inconvenient for the driver to adjust a sight line to a place in which the navigation device is mounted, which may cause an occurrence of distraction.

In addition, when guiding a route to a destination, the navigation device provides only driving direction information of the overall lanes of a traveled road without providing lane change guidance information based on a lane in which a vehicle is driving, and therefore it is difficult for the driver to check driving direction information of the lane, which may cause the occurrence of distraction.

### SUMMARY OF THE INVENTION

The present invention is directed to an apparatus and method of assisting a lane change based on augmented reality, which provides lane change information based on augmented reality when it is necessary to change a lane while a driver drives a vehicle to a destination.

According to an aspect of the present invention, there is provided a method of assisting a lane change based on augmented reality, including: detecting, from a front image obtained by photographing a front side of a driving vehicle, driving lane information indicating in what lane the vehicle is currently driving; generating traveled road model information obtained by mapping lane driving direction information calculated by received GPS signals and the detected driving lane information; generating lane change information by combining route guidance information calculated by the GPS signals and the traveled road model information; and converting the lane change information into graphic information, and displaying the graphic information through an augmented reality-based display screen inside the vehicle.

According to another aspect of the present invention, there is provided an apparatus of assisting a lane change based on augmented reality, including: a lane detection unit that detects driving lane information indicating in what lane the vehicle is currently driving from a front image obtained by photographing a front side of a driving vehicle, using a lane detection algorithm; a traveled road model information generation unit that generates traveled road model information obtained by mapping lane driving direction information detected from GPS signals received through a GPS receiver and the detected driving lane information; a lane change model generation unit that generates lane change information by combining route guidance information calculated by the GPS signals and the traveled road model information, and modeling the generated lane change information into graphic information represented by a two-dimensional (2D) image coordinate system; a matching unit that receives driver's pupil position information detected in accordance with a pupil position detection algorithm and the graphic information, converts the graphic information into augmented reality-based graphic information by converting the 2D image coordinate system into an augmented reality-based three-dimensional (3D) image coordinate system, and matches position information of the lane change information included in the augmented reality-based graphic information with the pupil position information; and a graphic processing unit that performs rendering on the matched augmented reality-based graphic information and outputs the augmented reality-based graphic information on which rendering has been performed to a transparent display device provided in front of a driver's seat inside the vehicle.

According to still another aspect of the present invention, there is provided a method of assisting a lane change based on augmented reality, including: detecting, from a front image obtained by photographing a front side of a driving vehicle, driving lane information indicating in what lane the vehicle is currently driving; generating traveled road model information obtained by mapping lane driving direction information calculated by received GPS signals and the detected driving lane information; generating lane change information by combining route guidance information calculated by the GPS signals and the traveled road model information; converting the generated lane change information into a graphic object selected by a user; extracting a display region in which the graphic object is displayed from a lane image obtained by removing a background from the front image through a lane detection algorithm; modeling the lane change information into a lane change graphic by mapping the graphic object on the extracted display region; and displaying the modeled lane change graphic on an augmented reality-based display screen inside the vehicle.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is illustrates lane change guidance information based on augmented reality according to an exemplary embodiment of the present invention;

FIG. 2 is a block diagram illustrating a configuration of an apparatus of assisting a lane change according to an exemplary embodiment of the present invention;

FIG. 3 is a functional block diagram illustrating a configuration of a lane detection unit shown in FIG. 2;

FIG. 4 is a functional block diagram illustrating a configuration of a route search unit shown in FIG. 2;

FIG. 5 is a functional block diagram illustrating a configuration of a pupil position detection unit shown in FIG. 2;

FIG. 6 is a functional block diagram illustrating a configuration of a traveled road model generation unit shown in FIG. 2;

FIG. 7 is a conceptual diagram illustrating a method of generating a traveled road model in the traveled road model generation unit shown in FIG. 2;

FIG. 8 is a functional block diagram illustrating a configuration a lane change model generation unit shown in FIG. 1;

FIG. 9 is a diagram illustrating a process of generating lane change information performed in the lane change model generation unit shown in FIG. 1;

FIG. 10 is a diagram illustrating a process of generating lane change graphic information performed in a graphic information generation unit shown in FIG. 9;

FIGS. 11A to 11E are diagrams illustrating five display regions shown in FIG. 10;

FIG. 12 is a block diagram illustrating a configuration of an augmented reality matching unit shown in FIG. 2;

FIG. 13 is a flowchart illustrating a method of assisting a lane change based on augmented reality according to an exemplary embodiment of the present invention.

### DETAILED DESCRIPTIONS OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications may be made without departing from the spirit and scope of the invention.

The present invention relates to an apparatus and method of assisting a lane change based on augmented reality which determines a situation in which it is necessary to change a driving lane and provides lane change information in line sight line of a driver, thereby eliminating driver's distraction and readily performing a lane change.

Hereinafter, an exemplary embodiment of the present invention will be described in detail with the accompanying drawings.

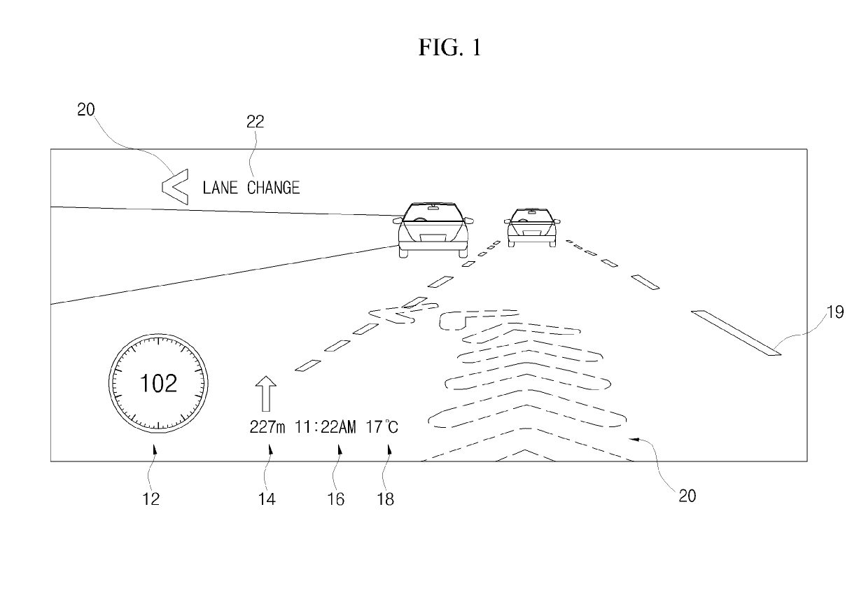

FIG. 1 is illustrates lane change guidance information based on augmented reality according to an exemplary embodiment of the present invention.

As shown in FIG. 1, lane change guidance information based on augmented reality according to an embodiment of the present invention may be provided in such a manner as to be overlapped (mapped) with an actual traveled road through a transparent display screen 19 positioned in front of a driver. Such lane change guidance information based on augmented reality may be displayed as various augmented images such as characters, numerals, or a variety of augmented images having specific shapes. For example, as shown in FIG. 1, the augmented images may include a speedometer-like image 12 informing a current driving speed, text-like images 14, 16, and 18 such as characters, numerals, signs, or a combination thereof, and an arrow head-like image 20 indicating a lane change. Here, reference numerals 14, 16, and 18 respectively indicate a distance from a current driving position to a lane change position, a present time, and an external air temperature of a vehicle. In this manner, the lane change guidance information based on augmented reality according to an embodiment of the present invention is provided in such a manner as to be overlapped (mapped) with the actual traveled road through a transparent display device positioned in front of the driver, thereby preventing distraction while driving and improving recognition of the lane change information, to increase safety and convenience of the driving.

Hereinafter, an apparatus of assisting a lane change based on augmented reality according to an embodiment of the present invention, which provides the lane change guidance information based on augmented reality shown in FIG. 1, will be described in detail.

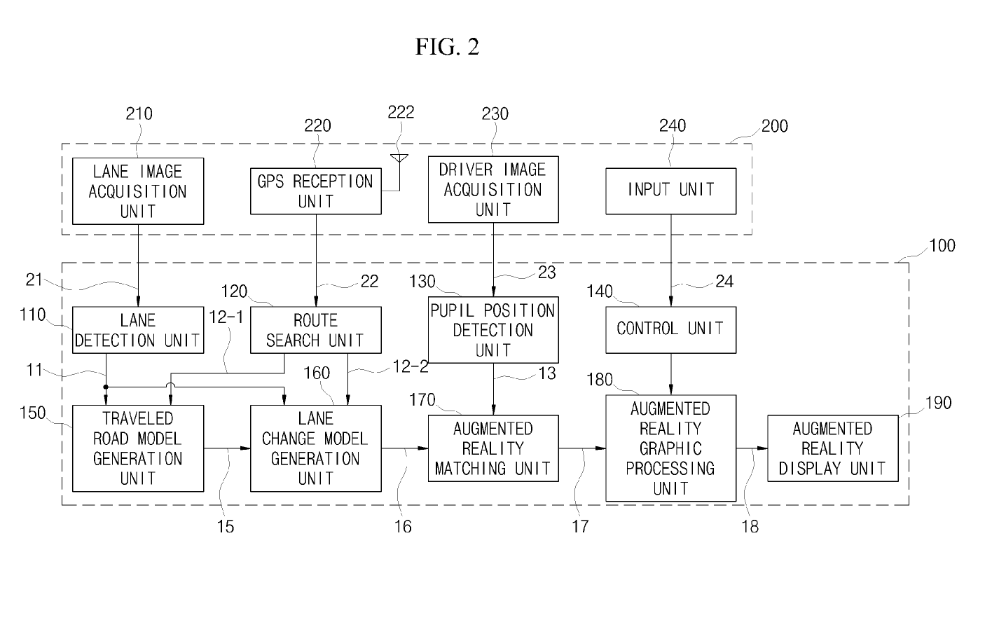

FIG. 2 is a block diagram illustrating a configuration of an apparatus of assisting a lane change according to an exemplary embodiment of the present invention.

Referring to FIG. 2, an apparatus 100 of assisting a lane change according to an embodiment of the present invention receives lane image information 21, vehicle's position information 22, driver's pupil image information 23, and user input information 24 from a peripheral device 200, and provides the lane change guidance information based on augmented reality as shown in FIG. 1.

First, the peripheral device 200 will be briefly described, and then the apparatus of assisting the lane change according to an embodiment of the present invention will be described.

The peripheral device 200 includes a lane image acquisition unit 210, a Global Positioning System (GPS) reception unit 220, a driver image acquisition unit 230, and an input unit 240 in order to respectively provide the lane image information 21, the vehicle's position information 22, the driver's pupil image information 23, and the user input information 24 to the apparatus 100 of assisting the lane change. The lane image acquisition unit 210 may acquire the lane image information 21 by photographing a lane that appears in front of a vehicle in order to determine the lane of a traveled road in the apparatus 100 of assisting the lane change, and may be a camera that is mounted in a specific position inside or outside the vehicle in order to image the front side of the vehicle. The GPS reception unit 220 receives GPS information from a GPS satellite through a GPS reception antenna 222, and the GPS information includes latitude and longitude data as the vehicle's position information 22 on a current map. The driver image acquisition unit 230 may acquire the driver's pupil image information 23 by photographing a driver in order to determine the driver's pupil position in the apparatus 100 of assisting the lane change, and may be a camera that is mounted in a specific position inside the vehicle in order to image the driver. The input unit 240 may acquire the user input information 24 for controlling operations of the apparatus 100 of assisting the lane change in response to a user's input, and may be implemented by various interfaces connecting the driver with the apparatus 100 of assisting the lane change. In FIG. 2, an example in which the peripheral device 200 and the apparatus 100 of assisting the lane change are separately provided is shown, but the peripheral device 200 may be provided inside the apparatus 100 of assisting the lane change.

The apparatus 100 of assisting the lane change includes a lane detection unit 110, a route search unit 120, a pupil position detection unit 130, a control unit 140, a traveled road model generation unit 150, a lane change model generation unit 160, an augmented reality matching unit 170, an augmented reality graphic processing unit 180, and an augmented reality display unit 190, in order to receive the information 21, 22, 23, and 24 from the peripheral device 200 and provide the lane change guidance information based on augmented reality as shown in FIG. 1.

The lane detection unit 110 receives the lane image information 21 from the lane image acquisition unit 210, and detects lane information 11 of the traveled road using the received lane image information 21.

The route search unit 120 receives the GPS information 22 from the GPS reception unit 220, searches for a route to a destination using the received GPS information 22, and detects lane driving direction information 12-1 on a current position of the driving vehicle and route guidance information 12-2 based on the search result.

The pupil position detection unit 130 detects driver's pupil position information 13 using the driver's pupil image information 23 from the driver image acquisition unit 230.

The control unit 140 controls overall operations of respective components 110 to 130 and 150 to 190 inside the apparatus 100 of assisting the lane change, receives the user input information 24 from the input unit 240, and controls operations of the augmented reality graphic processing unit 180 in accordance with the received user input information.

The traveled road model generation unit 150 receives the lane information 11 from the lane detection unit 110 and the lane driving direction information 12-1 from the route search unit 120, and generates road model information of a road on which the vehicle is driving using the received lane information 11 and lane driving direction information 12.

The lane change model generation unit 160 determines whether to change a lane using traveled road model information 15 from the traveled road model generation unit 150 and the route guidance information 12-2 from the route search unit 120, and generates lane change graphic information 16 obtained by modeling the lane change based on the determination result.

The augmented reality matching unit 170 receives the lane change graphic information 16 from the lane change model generation unit 160 and the driver's pupil position information 13 from the pupil position detection unit 130, and generates augmented reality-based lane change graphic information 17 by matching the lane change graphic information 16 with the driver's pupil position.

The augmented reality graphic processing unit 180 receives the augmented reality-based lane change graphic information 17 from the augmented reality matching unit 170, and performs rendering on the received augmented reality-based lane change graphic information 17.

The augmented reality display unit 190 receives the augmented reality-based lane change graphic information 18 on which rendering has been performed from the augmented reality graphic processing unit 180, and displays the received augmented reality-based lane change graphic information 18 through the transparent display screen 19 shown in FIG. 1.

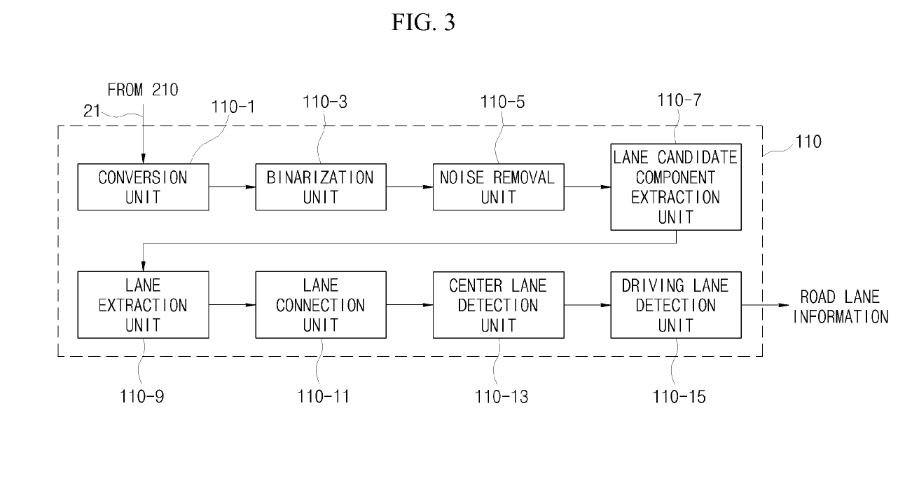

Hereinafter, the respective components of the apparatus 100 of assisting the lane change shown in FIG. 2 will be described in detail with reference to FIG. 3.

FIG. 3 is a functional block diagram illustrating a configuration of a lane detection unit shown in FIG. 2.

Referring to FIG. 3, the lane detection unit 110 detects at least one piece of information among information regarding the number of lanes, a lane pattern, a center lane index, and a driving lane index by performing image processing on the lane image information 21 acquired from the lane image acquisition unit 210. For this, the lane detection unit 110 includes a red, green, and blue (RGB) conversion unit 110-1, a binarization unit 110-3, a noise removal unit 110-5, a lane candidate component extraction unit 119-7, a lane extraction unit 110-9, a lane connection unit 110-11, a center lane detection unit 110-13, and a driving lane detection unit 110-15. The RGB conversion unit 110-1 receives the lane image information 21 from the lane image acquisition unit 210, and converts an RGB value of each pixel included in the lane image information 21 into a Hue Saturation Value (HSV) including brightness components or a brightness value such as an YCbCr value. The binarization unit 110-3 receives the brightness value from the RGB conversion unit 110-1, and converts the received brightness value into a digital binary value. The noise removal unit 110-5 receives the binary value, and removes a noise component included in the received binary value. The lane candidate component extraction unit 110-7 extracts pixels including a lane candidate component from binary value pixels whose noise is removed. The lane extraction unit 110-9 extracts pixels corresponding to a lane based on a vanishing point and a straight line/curved line model from the extracted pixels, thereby extracting the lane. The lane connection unit 110-11 performs a thinning process on the lane extracted by the lane extraction unit 110-9, and connects separate lanes. The center lane detection unit 110-13 detects a center lane based on color values among lanes connected by one straight line by the lane connection unit 110-11. The driving lane detection unit 110-15 detects a driving lane based on the position and inclination of the lane among the lanes connected by one straight line by the lane connection unit 110-10. That is, the driving lane detection unit 110-15 may classify the lanes connected by one straight line into left and right sides with respect to an imaginary central line crossing a middle portion of each lane image vertically, and detects two lanes which are closest to the imaginary central line and have different inclinations as the driving lane among the lanes. Only the left lane of the detected two lanes may be detected as the driving lane, as necessary.

Meanwhile, other than the method of detecting the lane by the lane detection unit 110, various lane detection algorithms may be used. For example, as the lane detection algorithm, Hough transformation lane detection, deformable template model lane detection, training-based lane detection, dynamic programming lane detection, or the like may be used in accordance with the method of detecting the lane. In the case of the deformable template model lane detection, boundary information is extracted, and then a likelihood function is defined in order to detect a lane satisfying a defined road model. In order to detect the lane satisfying the likelihood function, an algorithm, such as the metropolis algorithm, or simulated annealing may be used. In the case of the training-based lane detection, an algorithm, such as a support vector machine (SVM), or a neural network is used, and the lane may be detected through a pre-trained classifier. In the case of the dynamic programming lane detection, areas are divided, and then a function for lane detection is defined using restrictions such that the lane between the respective areas has a slight degree of continuity and does not exceed a certain angle. A set of the areas which most satisfies the defined function is detected as the lane. Finally, in the case of the Hough transformation lane detection, a boundary of an image may be extracted, and a lane may be detected using the Hough transformation.

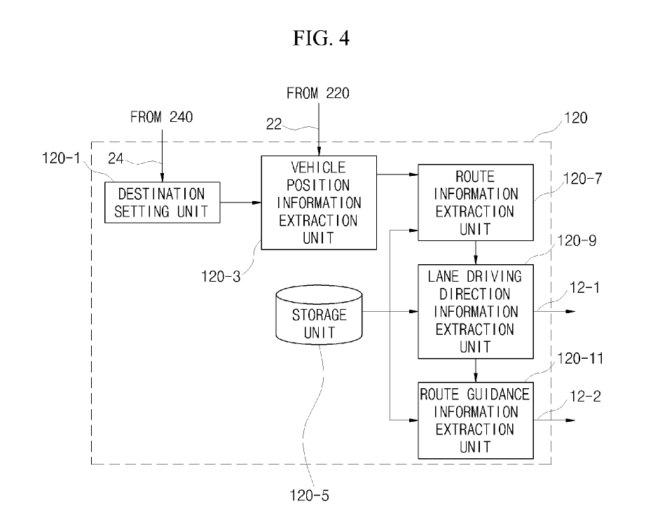

FIG. 4 is a functional block diagram illustrating a configuration of a route search unit shown in FIG. 2.

Referring to FIG. 4, the route search unit 120 includes a destination setting unit 120-1, a vehicle position information extraction unit 120-3, a digital map storage unit 120-5, a route information extraction unit 120-7, a lane driving direction information extraction unit 120-9, and a route guidance information extraction unit 120-11, in order to extract the lane driving direction information 12-1 and the route guidance information 12-2 using the GPS information from the GPS reception unit 220. The destination setting unit 120-1 receives the user input information 24 from the input unit 240, and sets a destination. The vehicle position information extraction unit 120-3 receives the GPS information from the GPS reception unit 220, and extracts vehicle position information calculated by the received GPS information. The digital map storage unit 120-5 outputs stored map data to the route information extraction unit 120-7, the lane driving direction information extraction unit 120-9, and the route guidance information extraction unit 120-11. The route information extraction unit 120-7 maps a vehicle's current position coordinates included in the vehicle position information from the vehicle position information extraction unit 120-3 and destination coordinates on the map data, and extracts the mapped result as the route information. The lane driving direction information extraction unit 120-9 extracts the lane driving direction information 12-1 using the route information extracted by the route information extraction unit 120-7 and the map data. The route guidance information extraction unit 120-11 extracts the route guidance information 12-2 using the lane driving direction information 12-1 extracted by the lane driving direction information extraction unit 120-9 and the map data.

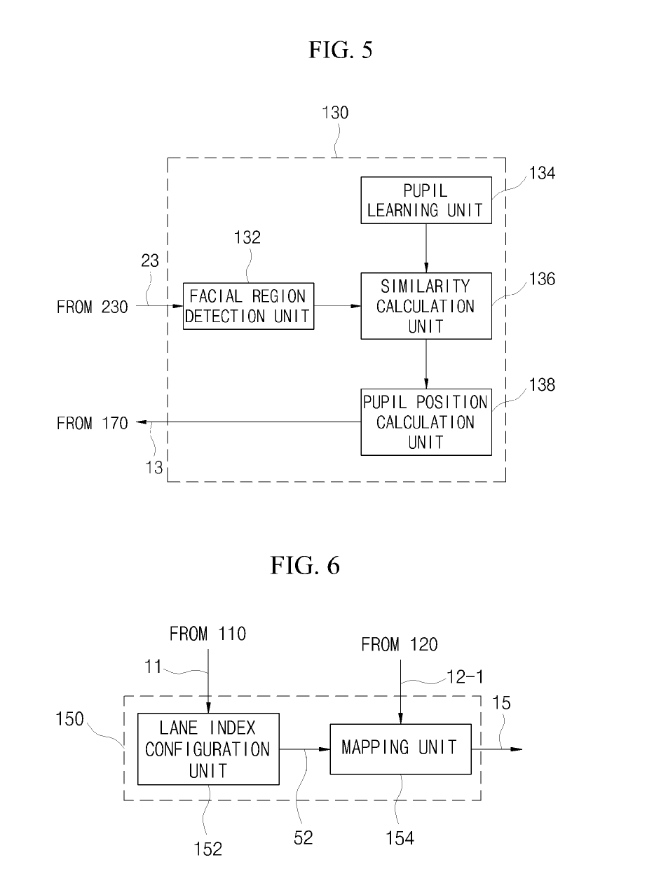

FIG. 5 is a functional block diagram illustrating a configuration of a pupil position detection unit shown in FIG. 2.

Referring to FIG. 5, the pupil position detection unit 130 includes a facial region detection unit 132, a pupil learning unit 134, a similarity calculation unit 136, and a pupil position calculation unit 138, in order to detect a driver's pupil position.

The facial region detection unit 132 detects a driver's facial region from the driver's pupil image information 23 acquired from the driver image acquisition unit 230 using a variety of face detection algorithms such as an adaboost classifier. The pupil learning unit 134 receives a plurality of face images or a plurality of user's pupil position-related images in advance, and learns the user's pupils through predetermined learning about pixels of the user's pupil position. That is, the pupil learning unit 130 extracts various users' pupils to acquire average pupil characteristics, and therefore learn the general positioning of pupils. The similarity calculation unit 136 calculates pupil similarity concerning each pixel of the face image through comparison between the face image detected by the facial region detection unit 132 and the pupil image learned by the pupil learning unit 140. Next, the similarity calculation unit 136 calculates the pupil position among the results by calculating the similarity. Here, the pupil position is a point including a pixel exceeding a predetermined threshold value corresponding to pupils. The pupil position calculation unit 138 calculates a geometric pupil position of a point at which user's pupils are actually positioned, using the point including the pixel corresponding to the pupil position calculated by the similarity calculation unit 120. That is, the pupil position calculation unit 138 calculates the geometric pupil position using an angle of both eyes' directions from a camera, a distance between the both eyes, or the like.

FIG. 6 is a functional block diagram illustrating a configuration of a traveled road model generation unit shown in FIG. 2.

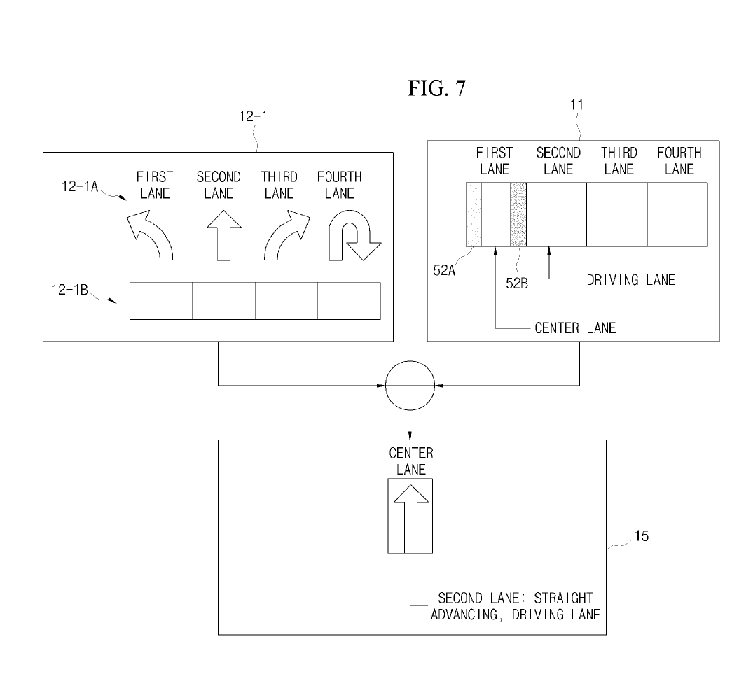

Referring to FIG. 6, the traveled road model generation unit 150 generates a traveled road model using the lane information 11 from the lane detection unit 110 and the lane driving direction information 12-1 from the route search unit 120. For this, the traveled road model generation unit 150 includes a lane index configuration unit 152 and a mapping unit 154. The lane index configuration unit 152 configures lane index information 52 indicating a driving lane in which a vehicle is currently driving, using the lane information 11 detected by the lane detection unit 110. The mapping unit 154 generates the traveled road model information 15 by mapping the lane driving direction information 12-1 provided by the route search unit 120 and the lane index information 52 configured by the lane index configuration unit 152. Hereinafter, a method of generating a traveled road model performed in the traveled road model generation unit will be described with reference to FIG. 7.

FIG. 7 is a conceptual diagram illustrating a method of generating a traveled road model in a traveled road model generation unit shown in FIG. 2.

As shown in FIG. 7, the lane driving direction information 12-1 includes a lane driving direction 12-1A indicating left turn, right turn, straight, or U turn and the number of lanes of a current road 12-1B (four lanes in an embodiment of the present invention is shown), and the lane information 11 includes a driving lane defined by a driving lane 52B in which a vehicle is currently driving, with respect to a center road defined by a center lane 52A. Driving direction information of all lanes of the traveled road may be acquired through the lane driving direction information 12-1 received from the route search unit 120, but in what lane the vehicle is currently driving may not be determined using only the driving direction information of all lanes. On the other hand, in which lane the vehicle is currently driving may be determined through the lane information 11 received from the lane extraction unit 110, but the lane driving direction 12-1A of all lanes of the traveled road may not be acquired. Thus, the traveled road model generation unit 150 maps the driving lane of the currently driving vehicle on the lane driving direction of the vehicle by combining the lane driving direction information 12-1 received from the route search unit 120 and the lane information 11 received from the lane extraction unit 110, thereby generating the traveled road model. For example, when it is determined that the lane in which the vehicle is currently driving is the second lane through the lane information 11 and the vehicle driving direction is a straight direction through the lane driving direction information 12-1, the traveled road model information on which the second lane and the straight direction are mapped may be modeled as shown in a reference numeral 15 of FIG. 7.

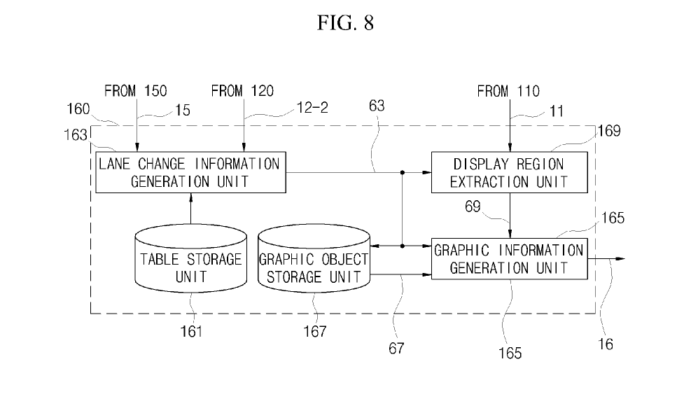

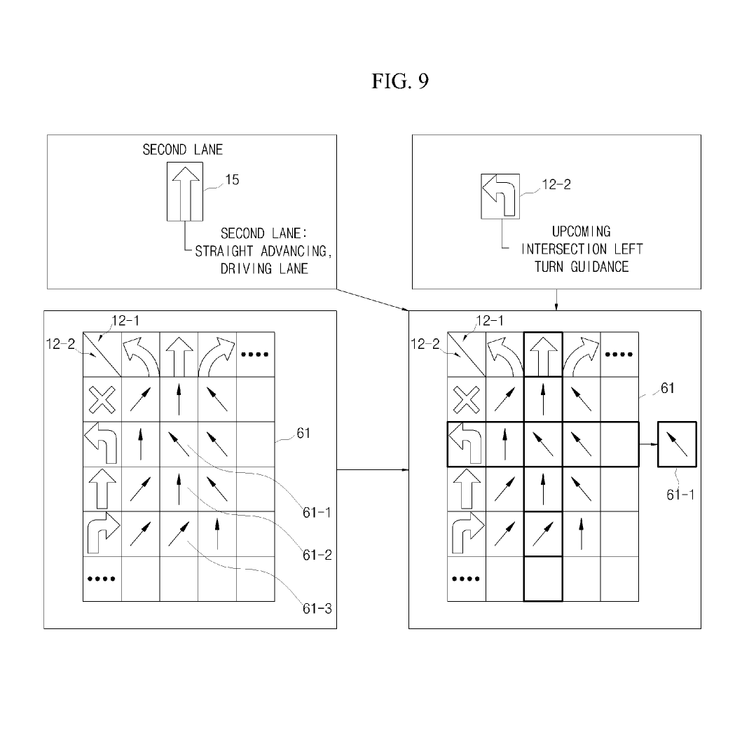

FIG. 8 is a functional block diagram illustrating a configuration of the lane change model generation unit shown in FIG. 1, and FIG. 9 is a diagram illustrating a process of generating lane change information performed in the lane change model generation unit shown in FIG. 1.

Referring to FIG. 8, the lane change model generation unit 160 generates the lane change graphic information 16 using the traveled road model information 15 from the traveled road model generation unit 150, the route guidance information 12-2 from the route search unit 120, and the lane information 11 from the lane detection unit 110. For this, the lane change model generation unit 160 includes a table storage unit 161, a lane change information generation unit 163, a graphic information generation unit 165, a graphic object storage unit 167, and a display region extraction unit 169.

The table storage unit 161 stores a lane change mapping table 61 for generating lane change information 63. The lane change mapping table 61 is a table that defines a mapping relationship between the lane driving direction information 12-1 and the route guidance information 12-2. That is, the lane change mapping table is a table obtained by calculating lane continuation and lane change in advance, assuming that the lane driving direction information 12-1 of the driving vehicle and the route guidance information 12-2 on an upcoming intersection, a crossroad, entry/exit roads, and the like are given. A reference numeral 61 of FIG. 9 is an example of the lane change mapping table, and is a table that is applied to countries in which road traffic laws are based on right-hand traffic. Thus, in the countries in which right-hand traffic is the rule such as in the United Kingdom, the directions of all arrows within the lane change mapping table may be configured in the opposite directions.

As shown in FIG. 9, when the lane driving direction information is straight and the route guidance information is left turn, that is, when a vehicle is driving in a straight lane and needs to turn left at the upcoming intersection, lane change information 61-1 indicating a change to a left lane is stored in the lane change mapping table 61. This means that a change from a current lane to the left lane is needed when the vehicle needs to turn left at the upcoming intersection while driving in the straight advancing lane. When the lane driving direction information is straight advancing and the route guidance information is straight advancing, that is, when the vehicle needs to go straight at the upcoming intersection while driving in the straight advancing lane, lane change information 61-2 indicating straight advancing is stored in the lane change mapping table 61. This means that the current lane needs to be maintained when the vehicle needs to go straight at the upcoming intersection while driving in the straight advancing lane. When the lane driving direction information is straight advancing and the route guidance information is right turn, that is, when the vehicle needs to turn right at the upcoming intersection while driving in the straight advancing lane, lane change information 61-3 indicating a change to a right lane is stored in the lane change mapping table 61. This means that a change from the current lane to the right lane is needed when the vehicle needs to turn right at the upcoming intersection while driving in the straight advancing lane.

The lane change information generation unit 163 receives a lane change mapping table 61 from the table storage unit 161, the traveled road model information 15 from the traveled road model generation unit 150, and the route guidance information 12-2 from the route search unit 120. The lane change information generation unit 163 generates lane change information 63 mapped on the traveled road model generation unit 150 and the route guidance information 12-2 by referring to the lane change mapping table 61. A process of generating the lane change information shown in FIG. 9 is a process in which the lane change information 61-1 stored in the lane change mapping table 61 is generated. Here, when the driving lane is the second lane and the lane change information generation unit 163 receives the traveled road model information 15 obtained by modeling the lane driving direction into straight advancing and the route guidance information 12-2 assisting a left turn at the upcoming intersection, an example in which the lane change information 61-1 that is respectively mapped on the information 15 and 12-2 is generated within the lane change mapping table 61 is shown.

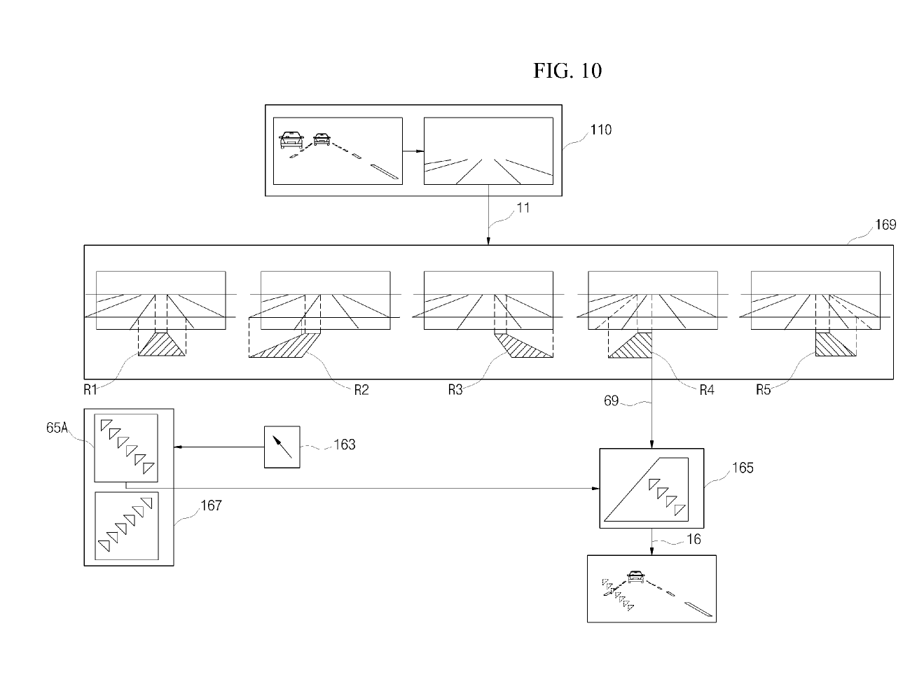

The graphic information generation unit 165 receives lane change information 63 from the lane change information generation unit 163, graphic object information 67 from the graphic object storage unit 167, and display region information 69 from the display region extraction unit 169, and generates the lane change graphic information 16 obtained by converting the lane change information 63 into the graphic type information using the graphic object information 67 and the display region information 69. A process of generating the lane change graphic information will be described in detail with reference to FIG. 10.

The graphic object storage unit 167 stores various graphic objects visually representing a lane change direction included in the lane change information 63.

The display region extraction unit 169 extracts a display region on which graphic objects corresponding to the lane change direction are displayed on the display screen. The display region may be defined by lanes included in the lane information 11 from the lane detection unit 110 and a region formed by two imaginary lines crossing these lanes.

Hereinafter, a process of generating the lane change graphic information will be described with reference to FIG. 10.

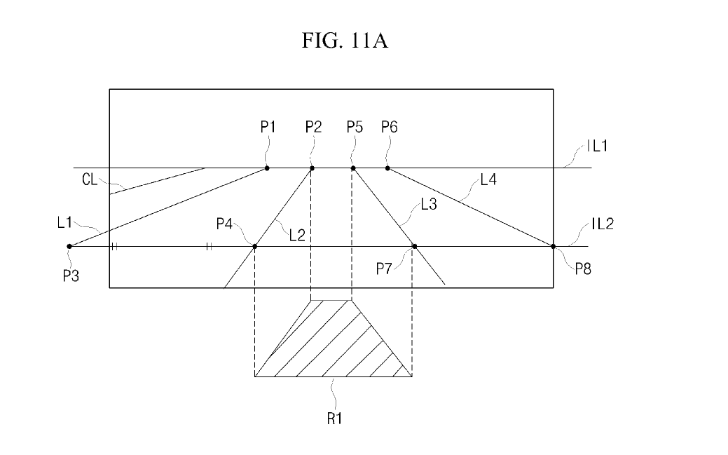

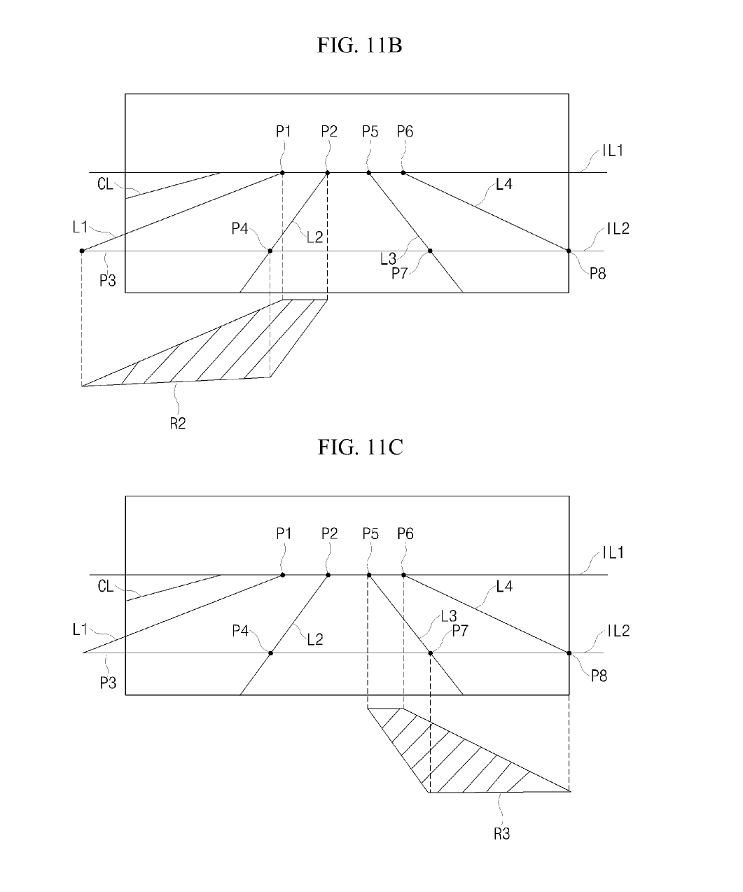

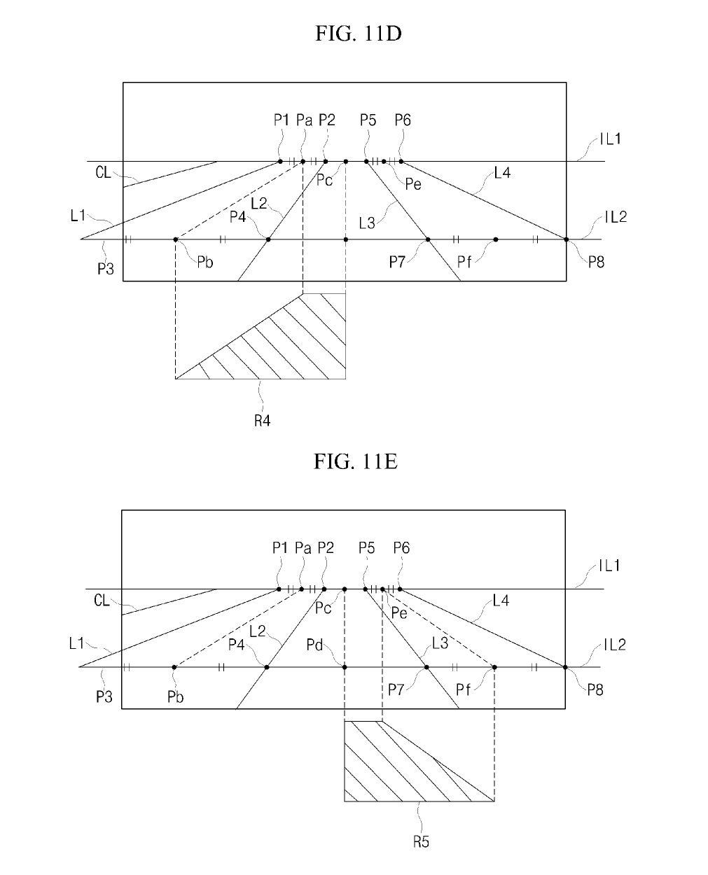

FIG. 10 FIG. 10 is a diagram illustrating a process of generating lane change graphic information performed in the graphic information generation unit shown in FIG. 9, and FIGS. 11a to 11e are diagrams illustrating five display regions shown in FIG. 10.

Referring to FIG. 10, when the display region extraction unit 169 receives the lane information detected by the lane detection unit 110, a process of extracting the display region within the display screen for displaying the lane change information is performed using the received lane information. Various types of display regions may be defined in accordance with a designer. Although not particularly limited, in an embodiment of the present invention, five display regions including a driving lane display region R1, a left lane display region R2, a right lane display region R3, a left center display region R4, and a right center display region R5 are defined. Hereinafter, the five display regions will be described in detail with reference to FIGS. 11a to 11e. First, it is assumed a case in which one center lane CL and four lanes L1 to L4 are detected by the lane detection unit 110. Thus, the driving lane is defined by the lanes L2 and L3, the left lane is defined by the lanes L1 and L2, and the right lane is defined by the lanes L3 and L4. In order to extract the five display regions, when the display screen is viewed from the front, two imaginary lines IL1 and IL2 which cross the lanes CL1 and L1 to L4 horizontally and are extended in parallel with each other are defined. As shown in FIG. 11A, the driving lane display region R1 is defined as a region formed by the lanes L2 and L3 defining the driving lane and the two imaginary lines IL1 and IL2 crossing the lanes L2 and L3 horizontally. As shown in FIG. 11B, the left lane display region R2 is defined as a region formed by the lanes L1 and L2 defining the left lane and the two imaginary lines IL1 and IL2 crossing the lanes L1 and L2 horizontally. As shown in FIG. 11C, the right lane display region R3 is defined as a region formed by the lanes L3 and L4 defining the right lane and the two imaginary lines IL1 and IL2 crossing the lanes L3 and L4 horizontally. As shown in FIG. 11D, the left center display region R4 is defined as a region formed by connecting, by straight lines, a point Pa bisecting a line segment connecting two points P1 and P2 at which the imaginary line IL1 and the lanes L1 and L2 intersect, a point Pb bisecting a line segment connecting two points P3 and P4 at which the imaginary line IL2 and the lanes L1 and L2 intersect, a point Pc bisecting a line segment connecting two points P2 and P5 at which the imaginary line IL1 and the lanes L2 and L3 intersect, and a point Pd bisecting a line segment connecting two points P4 and P7 at which the imaginary line IL2 and the lanes L2 and L3 intersect. As shown in FIG. 11E, the right center display region R5 is defined as a region formed by connecting, by straight lines, a point Pe bisecting a line segment connecting two points P5 and P6 at which the imaginary line IL1 and the lanes L3 and L4 intersect, a point Pf bisecting a line segment connecting two points P7 and P8 at which the imaginary line IL2 and the lanes L3 and L4 intersect, the point Pc, and the point Pd.

Referring again to FIG. 10, the graphic information generation unit 165 selects any one display region among the lane change display regions R1, R2, R3, R4, and R5 provided from the display region extraction unit 169 in accordance with the lane change information 63 received from the lane change information generation unit 163. For example, when the graphic information generation unit 165 receives the lane change information 63 instructing a change to the left lane, any one display region is selected among the driving lane display region R1, the left lane display region R2, and the left center display region R4, and when the graphic information generation unit 165 receives the lane change information 63 instructing a change to the right lane, any one display region is selected among the driving lane display region R1, the right lane display region R3, and the right center display region R5.

When the display region is selected, the graphic information generation unit 165 receives the graphic object information 65 corresponding to the lane change information 63 among the graphic object information stored in the graphic object storage unit 167, and generates the lane change graphic information 16 obtained by mapping the received graphic object information 65 on the selected display region. For example, as shown in FIG. 10, when the graphic information generation unit 165 receives the lane change information 63 instructing a change to the left lane, the graphic object information 65 including a left lane graphic object 65A visually representing a change to the left lane and the display region information 69 including the left center display region R4 selected by the user are received, and the lane change graphic information 16 obtained by mapping the left lane graphic object 65A on the left center display region R4 is generated.

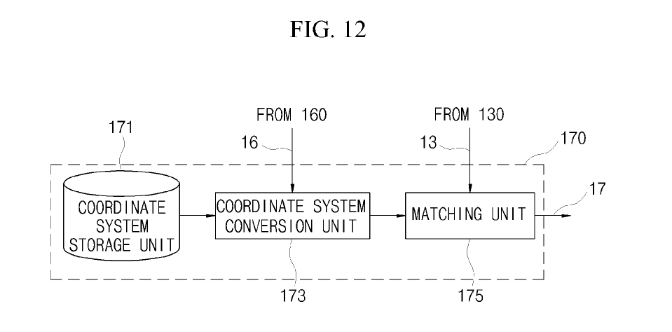

FIG. 12 is a block diagram illustrating a configuration of an augmented reality matching unit shown in FIG. 2

Referring to FIG. 12, the augmented reality matching unit 170 generates augmented reality-based lane change graphic information that is displayed in a position matched to the viewpoint of a driver, using the lane change graphic information 16 from the lane change model generation unit and the driver's pupil position information 13 from the pupil position detection unit 130. For this, the augmented reality matching unit 170 includes a coordinate system storage unit 171, a coordinate system conversion unit 173, and a matching unit 175. A vehicle-based coordinate system is stored in the coordinate system storage unit 171, and the stored coordinate system is input to the coordinate conversion unit 173.

The coordinate system conversion unit 173 receives the lane change graphic information 16 from the lane change model generation unit 160, and converts an image-based coordinate system used to represent the lane change graphic information 16 into a vehicle-based common coordinate system. Here, the vehicle-based common coordinate system refers to a coordinate system that is learned in advance in order to represent actual world information in front of a driver's seat based on the visual line direction and visual field angle of the driver included in driver's pupil position information. The lane change graphic information received from the lane change model generation unit 160 is represented by a coordinate system in accordance with an installation position of the lane image acquisition unit 210 provided in the vehicle. Here, the actual world information refers to information that is actually seen through a windshield in front of the driver's seat. Thus, when the augmented reality display unit 190 displays the lane change graphic information 16 based on the coordinate system in accordance with the installation position of the lane image acquisition unit 210, the lane change graphic information 16 is displayed in a viewpoint different from the viewpoint in accordance with the driver's pupil position. Thus, the coordinate system in accordance with the installation position of the lane image acquisition unit 210 representing the lane change graphic information 16 should be converted into the vehicle-based common coordinate system that may be matched to the viewpoint of the driver.

The matching unit 175 matches the lane change graphic information 16, that is converted so as to be represented by the vehicle-based common coordinate system, to the position of the actual world information in front of the driver's seat based on the visual line direction and the visual field angle included in the driver's pupil position information 13 received from the pupil position detection unit 130. That is, the matching unit 175 generates the augmented reality-based lane change graphic information 17 obtained by projecting, in a three-dimensional (3D) manner, the lane change graphic information 16 that is converted so as to be represented by the vehicle-based common coordinate system to the vehicle-based common coordinate system based on the driver's pupil position information 13. Then, the generated augmented reality-based lane change graphic information 17 is input to the augmented reality graphic processing unit 180, and the augmented reality graphic processing unit 180 performs rendering on the received augmented reality-based lane change graphic information 17 and inputs the augmented reality-based lane change graphic information 18 on which rendering has been performed to the augmented reality display unit 190. The augmented reality display unit 190 includes a transparent display device provided in the windshield in front of the driver's seat, and displays the augmented reality-based lane change graphic information 18 on which rendering has been performed, through the transparent display device.

Meanwhile, the control unit 140 shown in FIG. 2 determines the user input 24 that is input through the input unit 240 to control operations of the respective components 110, 120, 130, 150, 160, 170, 180, and 190 included in the apparatus of assisting the lane change, and determines a display method and a display time for assisting an augmented reality-based lane change based on the determined user input 24. Here, control of the display method means control of a method of representing information such as colors, sizes, graphic objects, animation support, and the like. The control of the display time means a method of controlling a distance and a time such as starting, maintaining, and stopping lane change assistance. For example, at the start of lane change assistance, the lane change assistance based on augmented reality may start at a position of 400 m before the upcoming intersection or 10 seconds before the vehicle reaches the upcoming intersection. In the maintaining of lane change assistance, the lane change assistance may be performed once per each 10 m, or the display cycle of the lane change assistance may be controlled through one-time flickering per second or the like. At the stop of the lane change assistance, the lane change assistance is stopped when the vehicle reaches a position spaced apart, by 10 m, from the intersection after the vehicle passes through the intersection, or the lane change assistance is stopped in one second after the vehicle passes through the intersection.

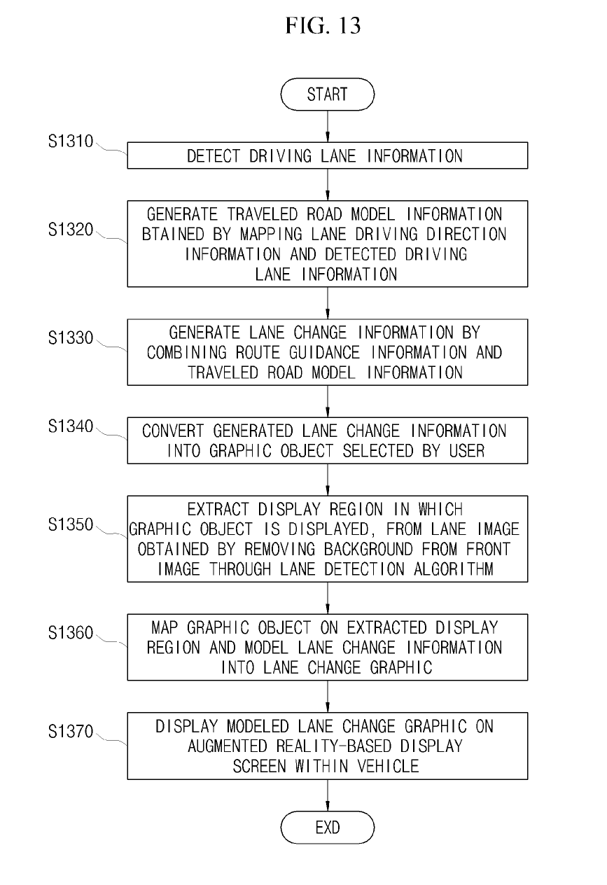

FIG. 13 is a flowchart illustrating a method of assisting a lane change based on augmented reality according to an exemplary embodiment of the present invention.

Referring to FIG. 13, in operation S1310, a process of detecting driving lane information is performed. Specifically, a process of photographing a front side of a driving vehicle through a camera provided in the vehicle, and a process of detecting a lane image from the photographed front image is performed using a lane detection algorithm. In this instance, the detected lane image includes a center lane detected based on color values and a plurality of lanes detected based on the center lane.

Next, in operation S1320, a process of generating traveled road model information is performed. The traveled road model information is information obtained by modeling the driving direction of the vehicle on a currently traveled road, and is generated by mapping lane driving direction information calculated by received GPS signals and the detected driving lane information.

Next, in operation S1330, a process of generating lane change information is performed. The lane change information is information generated by combining route guidance information calculated by the GPS signals and the traveled road model information, and specifically, may be generated by extracting the lane change information that is mapped by the route guidance information and the traveled road model information from a lane change mapping table calculated in advance, by referring to the lane change mapping table.

Next, in operation S1340, a process of converting the generated lane change information into a graphic object is performed. The graphic object may be represented in various forms visually representing lane change. For example, the graphic object may be a graphic image such as an arrow head.

Next, in operation S1350, a process of extracting a display region in which the graphic object is displayed is performed. The display region may be any one among a plurality of display regions which are defined by a plurality of lanes shown in the lane image and two imaginary lines crossing the plurality of lanes horizontally. Here, the two imaginary lines are constituted of an upper imaginary line IL1 that is extended so as to pass through a vanishing point at which the lanes are vanished and a lower imaginary line IL2 that is extended in parallel with the upper imaginary line ILL Specifically, the display region may be any one among a driving lane display region R1, a left lane display region R2, a right lane display region R3, a left center display region R4, and a right center display region R5. As an example, as shown in FIGS. 11a to 11e, the left lane display region R2 may be formed by the upper imaginary line ILL the lower imaginary line IL2, and the first and second lanes L1 and L2, the right lane display region R3 may be formed by the upper imaginary line ILL the lower imaginary line IL2, and the third and fourth lanes L3 and L4, and he driving lane display region R1 may be formed by the upper imaginary line ILL the lower imaginary line IL2, and the second and third lanes L2 and L3. In addition, the left center display region R4 may be formed by connecting, by straight lines, a point Pa bisecting a line segment connecting two points P1 and P2 at which the upper imaginary line IL1 and the first and second lanes L1 and L2 intersect, a point Pb bisecting a line segment connecting two points P3 and P4 at which the lower imaginary line IL2 and the first and second lanes L1 and L2 intersect, a point Pc bisecting a line segment connecting two points P2 and P5 at which the upper imaginary line IL1 and the second and third lanes L2 and L3 intersect, and a point Pd bisecting a line segment connecting two points P4 and P7 at which the lower imaginary line IL2 and the second and third lanes L2 and L3 intersect. In addition, the right center display region R5 may be formed by connecting, by straight lines, a point Pe bisecting a line segment connecting two points P5 and P6 at which the upper imaginary line IL1 and the third and fourth lanes L3 and L4 intersect, a point Pf bisecting a line segment connecting two points P7 and P8 at which the lower imaginary line IL2 and the third and fourth lanes L3 and L4 intersect, the point Pc, and the point Pd.

Next, in operation S1360, when the display region is extracted, a process of modeling the lane change information into a lane change graphic is performed. The process of modeling the lane change information may be performed by mapping the graphic object on the extracted display region.

Next, in operation S1370, when the lane change information is modeled into the lane change graphic, a process of displaying the modeled lane change graphic on an augmented reality-based display screen is performed. In this instance, the modeled lane change graphic is information represented by a two-dimensional (2D) image coordinate system, and therefore the lane change graphic is converted into an augmented reality-based graphic by converting the modeled lane change graphic into a 3D image coordinate system in order to display the modeled lane change graphic on the augmented reality-based display screen. Next, position information (coordinate information) representing the lane change graphic converted based on augmented reality and the driver's pupil position information detected by the pupil position detection unit 130 are matched, and the lane change graphic matched to the driver's pupil position information is displayed on the augmented reality-based display screen.

As described above, according to the embodiments of the present invention, when it is necessary to change a lane while a driver drives a vehicle to a destination, lane change guidance information based on augmented reality can be expressed in the sight line of the driver. Therefore, it is possible to eliminate inconvenience and distraction in the case of checking forward direction of the lane, thereby improving safety and convenience of the driving.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of assisting a lane change based on augmented reality, comprising:
detecting, from a front image obtained by photographing a front side of a driving vehicle, driving lane information indicating in what lane the vehicle is currently driving;
generating traveled road model information obtained by mapping lane driving direction information calculated by received GPS signals and the detected driving lane information;
generating lane change information by combining route guidance information calculated by the GPS signals and the traveled road model information; and
converting the lane change information into graphic information, and displaying the graphic information through an augmented reality-based display screen inside the vehicle.

2. The method of assisting a lane change of claim 1, wherein the traveled road model information is information indicating a current driving direction of the vehicle on a traveled road.

3. The method of assisting a lane change of claim 1, wherein the generating of the lane change information includes:
storing a lane change mapping table calculated in advance, and
generating the lane change information that is mapped on the route guidance information and the traveled road model information, by referring to the stored lane change mapping table, and
wherein the lane change mapping table stores a mapping relationship between the route guidance information and the lane driving direction information.

4. The method of assisting a lane change of claim 1, wherein the displaying of the graphic information includes
extracting a graphic object selected by a user from a storage unit that stores a plurality of graphic objects visually representing the lane change,
converting the lane change information into the graphic object selected by the user, and
displaying the graphic object as the graphic information through the display screen inside the vehicle.

5. The method of assisting a lane change of claim 1, wherein the detecting of the driving lane information includes
detecting a plurality of lanes included in the front image using a lane detection algorithm,
detecting center lane information indicating a center lane using color values of pixels constituting the detected plurality of lanes, and
detecting the driving lane information indicating a driving lane in which the vehicle is currently driving, based on position information of the center lane included in the detected center lane information.

6. An apparatus of assisting a lane change based on augmented reality, comprising:
a lane detection unit that detects driving lane information indicating in what lane the vehicle is currently driving from a front image obtained by photographing a front side of a driving vehicle, using a lane detection algorithm;
a traveled road model information generation unit that generates traveled road model information obtained by mapping lane driving direction information detected from GPS signals received through a GPS receiver and the detected driving lane information;
a lane change model generation unit that generates lane change information by combining route guidance information calculated by the GPS signals and the traveled road model information, and modeling the generated lane change information into graphic information represented by a two-dimensional (2D) image coordinate system;
a matching unit that receives driver's pupil position information detected in accordance with a pupil position detection algorithm and the graphic information, converts the graphic information into augmented reality-based graphic information by converting the 2D image coordinate system into an augmented reality-based three-dimensional (3D) image coordinate system, and matches position information of the lane change information included in the augmented reality-based graphic information with the pupil position information; and
a graphic processing unit that performs rendering on the matched augmented reality-based graphic information and outputs the augmented reality-based graphic information on which rendering has been performed to a transparent display device provided in front of a driver's seat inside the vehicle.

7. The apparatus of assisting a lane change of claim 6, wherein the traveled road model information is information indicating a current driving direction of the vehicle on a traveled road.

8. The apparatus of assisting a lane change of claim 6, wherein the lane change model generation unit includes
a storage unit that stores a lane change mapping table indicating a mapping relationship between the route guidance information and the lane driving direction information, and
a lane change information generation unit that generates the lane change information that is mapped on the route guidance information and the traveled road model information, by referring to the lane change mapping table.

9. The apparatus of assisting a lane change of claim 8, wherein the lane change model generation unit includes
a storage unit that stores a plurality of graphic objects visually representing the lane change, and
a graphic information generation unit that generates the graphic information by modeling the lane change information into the graphic object selected by a user among the plurality of graphic objects stored in the storage unit.

10. A method of assisting a lane change based on augmented reality, comprising:
detecting, from a front image obtained by photographing a front side of a driving vehicle, driving lane information indicating in what lane the vehicle is currently driving;
generating traveled road model information obtained by mapping lane driving direction information calculated by received GPS signals and the detected driving lane information;
generating lane change information by combining route guidance information calculated by the GPS signals and the traveled road model information;
converting the generated lane change information into a graphic object selected by a user;
extracting a display region in which the graphic object is displayed from a lane image obtained by removing a background from the front image through a lane detection algorithm;
modeling the lane change information into a lane change graphic by mapping the graphic object on the extracted display region; and
displaying the modeled lane change graphic on an augmented reality-based display screen inside the vehicle.

11. The method of assisting a lane change of claim 10, wherein the display region is any one among a plurality of regions defined by a plurality of lanes displayed in the lane image and two imaginary lines horizontally crossing the plurality of lanes.

12. The method of assisting a lane change of claim 11, wherein the two imaginary lines are constituted of an upper imaginary line that is extended so as to pass through a vanishing point at which the lanes are vanished and a lower imaginary line that is extended in parallel with the upper imaginary line.

13. The method of assisting a lane change of claim 12, wherein, when the plurality of lanes include a first lane, a second lane, a third lane, and a fourth lane, a left lane is defined by the first and second lanes, a driving lane is defined by the second and third lanes, and a right lane is defined by the third and fourth lanes, the display region is any one among a left lane display region formed by the upper imaginary line, the lower imaginary line, and the first and second lanes, a right lane display region formed by the upper imaginary line, the lower imaginary line, and the third and fourth lanes, and a driving lane display region formed by the upper imaginary line, the lower imaginary line, and the second and third lanes.

14. The method of assisting a lane change of claim 12, wherein, when the plurality of lanes include a first lane, a second lane, a third lane, and a fourth lane, a left lane is defined by the first and second lanes, a driving lane is defined by the second and third lanes, and a right lane is defined by the third and fourth lanes, the display region is any one among a left center display region that is formed by connecting, by straight lines, a point (Pa) bisecting a line segment connecting two points (P1 and P2) at which the upper imaginary line (IL1) and the first and second lanes (L1 and L2) intersect, a point (Pb) bisecting a line segment connecting two points (P3 and P4) at which the lower imaginary line (IL2) and the first and second lanes (L1 and L2) intersect, a point (Pc) bisecting a line segment connecting two points (P2 and P5) at which the upper imaginary line (IL1) and the second and third lanes (L2 and L3) intersect, and a point (Pd) bisecting a line segment connecting two points (P4 and P7) at which the lower imaginary line (IL2) and the second and third lanes (L2 and L3) intersect, and a right center display region that is formed by connecting, by straight lines, a point (Pe) bisecting a line segment connecting two points (P5 and P6) at which the upper imaginary line (IL1) and the third and fourth lanes (L3 and L4) intersect, a point (Pf) bisecting a line segment connecting two points (P7 and P8) at which the lower imaginary line (IL2) and the third and fourth lanes (L3 and L4) intersect, the point (Pc), and the point (Pd).

15. The method of assisting a lane change of claim 10, wherein the traveled road model information is information indicating a current driving direction of the vehicle on a traveled road.

16. The method of assisting a lane change of claim 10, wherein the generating of the lane change information includes
storing a lane change mapping table calculated in advance, and
generating the lane change information that is mapped on the route guidance information and the traveled road model information, by referring to the stored lane change mapping table, and
wherein the lane change mapping table stores a mapping relationship between the route guidance information and the lane driving direction information.
